(19) United States
(12) Patent Application Publication
(10) Pub. No.: US 2009/0141257 A1
(43) Pub. Date: Jun. 4, 2009

(54) Illumination optical apparatus, exposure apparatus, and method for producing device

(75) Inventor: Jin Nishikawa, Tokyo (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/292,384

(22) Filed: Nov. 18, 2008

Related U.S. Application Data
(60) Provisional application No. 60/996,613, filed on Nov. 27, 2007.

(51) Int. Cl. G03B 27/54; F21S 8/00; G03B 27/32

(52) U.S. Cl. 355/67; 362/268; 355/77

(57) ABSTRACT

A reflection type illumination optical apparatus, which guides an exposure light to a reticle surface via a curved mirror, a concave mirror, etc. includes a vacuum chamber which accommodates the curved mirror, the concave mirror, etc; and a subchamber which is arranged in the vacuum chamber and which accommodates the curved mirror. The subchamber has openings through which the exposure light coming into the curved mirror and the exposure light exiting from the curved mirror pass, respectively. Each of the openings is arranged in the vicinity of a position at which the cross-sectional area of the light flux is smallest. It is possible to decrease the amount of adhesion of minute particles such as debris to the reflecting optical element, without unnecessarily enhancing the ability of the vacuum gas discharge mechanism.

### CROSS-REFERENCES TO RELATED APPLICATIONS

This application claims the benefit of priority of U.S. Provisional Application No. 60/996,613 filed on Nov. 27, 2007, the entire disclosures of which are incorporated herein by reference.

### BACKGROUND OF THE INVENTION

1. Field of the Invention

The present invention relates to an illumination optical apparatus of the reflection type which guides an illumination light to a surface of an illumination objective (illumination objective surface), an exposure apparatus provided with the illumination optical apparatus, and a method for producing a device using the exposure apparatus.

2. Description of the Related Art

Recently, in order to enhance the resolution by shortening the exposure wavelength, an exposure apparatus (hereinafter referred to as “EUV exposure apparatus”) has been developed, which exposes a substrate such as a wafer via a reticle (mask) by using, as an exposure light beam (exposure light), an extreme ultraviolet light (hereinafter referred to as “EUV light”) which has a wavelength of, for example, not more than about 100 nm. In the EUV exposure apparatus, there is no optical member through which the EUV light is transmitted. Therefore, an illumination optical system, a projection optical system, etc. are constructed by using reflecting optical members, except for specific optical filters or the like. The reticle is also formed of a material of the reflection type.

The EUV light is absorbed by the gas. Therefore, the EUV exposure apparatus is installed in a vacuum chamber in which a vacuum atmosphere having an air pressure considerably lower than the atmospheric pressure is maintained (see, for example, Japanese Patent Application Laid-open No. 2004-152843). Further, as for a light source section, which includes a laser plasma light source, etc., is sometimes provided in a small-sized independent vacuum chamber in order to further enhance the degree of vacuum.

### SUMMARY OF THE INVENTION

In relation to the EUV exposure apparatus, the following fact is known. That is, when the exposure is continued, then debris (scattered particles), which are generated in the light source section, adhere to the reflecting surface of the reflecting optical member constructing the illumination optical system, and the reflectance of the reflecting surface is gradually lowered. In such a situation, it is necessary that a reflecting optical member, in which the reflectance is lowered below an allowable range, should be exchanged with another reflecting optical member. Upon exchanging the reflecting optical member, it is necessary to perform optical adjustment. Therefore, especially when the exchange frequency of the reflecting optical member is increased, the rate of operation of the exposure apparatus is greatly lowered.

In order to suppress the decrease in the reflectance of the reflecting surface of the reflecting optical member, the degree of vacuum may be improved and raised for the vacuum chamber in which the entire exposure apparatus is accommodated. However, in the case of such a countermeasure, the vacuum gas discharge mechanism is unnecessarily large-sized, and the operation cost of the exposure apparatus is increased.

Taking the foregoing circumstances into consideration, an object of the present invention is to provide a reflection type illumination technique which makes it possible to decrease the amount of adhesion of minute particles such as debris to the reflecting optical element, without unnecessarily enhancing the ability of the vacuum gas discharge mechanism; an exposure technique which uses the illumination technique; and a technique for producing a device which uses the exposure technique.

According to a first aspect of the present invention, there is provided a reflection type illumination optical apparatus which guides an illumination light to an illumination objective surface, the illumination optical apparatus comprising: a first chamber which accommodates a plurality of reflecting optical elements; and a second chamber which is arranged in the first chamber and which accommodates a first reflecting optical element among the plurality of reflecting optical elements; wherein the second chamber has a first opening through which a light flux of the illumination light coming into the first reflecting optical element passes, and a second opening through which the light flux of the illumination light reflected by the first reflecting optical element passes; the first opening is arranged at a position at which a cross-sectional area of the light flux coming into the first reflecting optical element is smallest or the first opening is arranged in the vicinity of the position; and the second opening is arranged at a position at which a cross-sectional area of the light flux reflected by the first reflecting optical element is smallest or the second opening is arranged in the vicinity of the position.

According to a second aspect of the present invention, there is provided a reflection type illumination optical apparatus which guides an illumination light to an illumination objective surface, the illumination optical apparatus comprising: a first chamber which accommodates a plurality of reflecting optical elements; a first gas discharge nozzle which is arranged in the vicinity of a reflecting surface of a first reflecting optical element among the plurality of reflecting optical elements; and a first gas discharge device which discharges a gas existing in the vicinity of the reflecting surface of the first reflecting optical element via the first gas discharge nozzle.

According to a third aspect of the present invention, there is provided a reflection type illumination optical apparatus which guides an illumination light to an illumination objective surface, the illumination optical apparatus comprising: a first chamber which accommodates a plurality of reflecting optical elements; and a second chamber which is arranged in the first chamber and which accommodates a first reflecting optical element among the plurality of reflecting optical elements; wherein the second chamber is provided with a cylindrical portion which extends from the second chamber so that a light flux of the illumination light, coming into or reflected by the first reflecting optical element, passes through an interior of the cylindrical portion; and a position, at which a cross-sectional area of the light flux coming into or reflected by the first reflecting optical element is smallest, exists in the cylindrical portion.

According to the present invention, there is provided an exposure apparatus comprising: the illumination optical apparatus of the present invention as defined above; and a projection optical system which projects, onto a projection surface, an image of a reflection type master plate arrangeable on the illumination objective surface; wherein the projection optical system is accommodated in a projection system chamber which is different from the first chamber. Further, according to the present invention, there is provided a method for producing a device, comprising exposing a substrate disposed on a projection surface by using the exposure apparatus according to the present invention; and processing the exposed substrate.

According to the first illumination optical apparatus of the present invention, the first reflecting optical element is accommodated in the individual chamber which has the opening formed on the optical path for the illumination light. As for the position of the opening, the cross-sectional area of the illumination light is small at the position. Therefore, it is possible to provide a small opening.

According to the second illumination optical apparatus of the present invention, the vacuum evacuation or the suction of the gas containing the minute particles is locally performed via the first gas discharge nozzle in the vicinity of the reflecting surface of the first reflecting optical element.

Therefore, according to the illumination optical apparatuses as described above, the minute particles, which include, for example, the debris diffused or scattered from the light source, hardly adhere to the first reflecting optical element. Further, since the vacuum evacuation, etc. is performed locally, it is unnecessary to excessively enhance the ability of the vacuum gas discharge mechanism as compared with a case in which the entire atmosphere is made to have a high degree of vacuum.

### BRIEF DESCRIPTION OF THE DRAWINGS

FIG. 1 shows a sectional view of a schematic construction of an exposure apparatus according to a first embodiment of the present invention.

FIG. 2A shows a first fly's eye optical system 22 shown in FIG. 1, and FIG. 2B shows a second fly's eye optical system 23 shown in FIG. 1.

FIG. 3A shows a perspective view of a subchamber 4C shown in FIG. 1, and FIG. 3B shows a perspective view of a subchamber 4D shown in FIG. 1.

FIG. 4 shows a sectional view of a schematic construction of an exposure apparatus according to a second embodiment of the present invention.

FIG. 5 shows a flow chart illustrating an example of steps of producing a device using the exposure apparatus of the embodiment described above.

### DESCRIPTION OF THE PREFERRED EMBODIMENTS

### First Embodiment

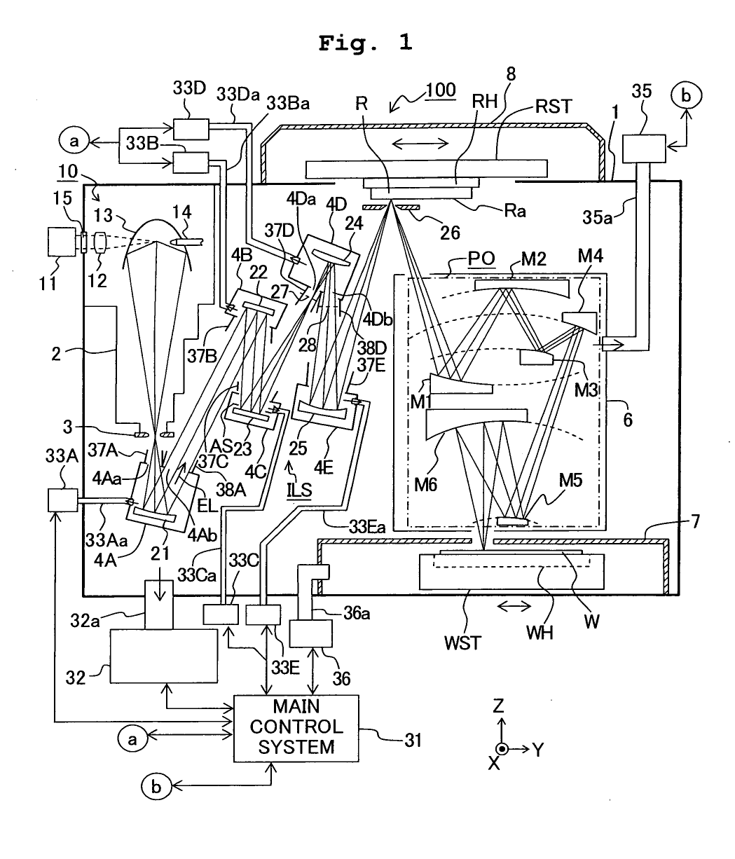

The first embodiment of the present invention will be explained with reference to FIGS. 1 to 3.

FIG. 1 shows a sectional view schematically illustrating the overall construction of an exposure apparatus (EUV exposure apparatus), 100 of this embodiment using an EUV light, in which the wavelength is within a range of about 3 to 50 nm, for example, 11 nm or 13 nm, as an exposure light EL (exposure light beam or illumination light). With reference to FIG. 1, the exposure apparatus 100 includes a laser plasma light source 10 which emits the exposure light EL; an illumination optical system (optical system) ILS which illuminates a reticle R (mask) with the exposure light EL; a reticle stage RST which moves the reticle R; and a projection optical system PO which projects an image of a pattern formed on a pattern surface (hereinafter referred to as “reticle surface”) Ra of the reticle R onto a wafer (photosensitive substrate) W coated with a resist (photosensitive material). The exposure apparatus 100 further includes a wafer stage WST which moves the wafer W; a main control system 31 which includes a computer integrally controlling the operation of the entire apparatus; a vacuum pump; etc.

In this embodiment, the EUV light is used as the exposure light EL. Therefore, the illumination optical system ILS and the projection optical system PO, except for specific filters (not shown), etc., are constructed by a plurality of reflecting optical members (reflecting optical elements). The reticle R is also constructed as the reflection type. Multilayered reflective films, which reflect the EUV light, are formed on the reticle surface Ra (reflecting surface) and the reflecting surfaces of the reflecting optical members. A circuit pattern is formed by an absorbing layer on the reflective film on the reticle surface Ra. In order to avoid the absorption of the exposure light EL by the gas, the substantially entire exposure apparatus 100 is accommodated in a box-shaped vacuum chamber 1. A large-sized vacuum pump 32 is provided in order to vacuum-evacuate the space in the vacuum chamber 1 via a gas discharge tube 32a. Further, a light source chamber 2, subchambers 4A to 4E of the illumination system, and a projection system chamber 6 (details will be described later on) are provided in order to further enhance the degree of vacuum on the optical path for the exposure light EL in the vacuum chamber 1.

The following description will be made with reference to FIG. 1 assuming that the Z axis extends in a direction of the normal line of a guide surface on which the wafer stage WST is moved (bottom surface of the vacuum chamber 1), the X axis extends perpendicularly to the sheet surface of FIG. 1 in a plane perpendicular to the Z axis, and the Y axis extends in parallel to the sheet surface of FIG. 1. In this embodiment, the illumination area of the exposure light EL on the reticle surface Ra has a circular arc-shaped form which is long in the X direction. The reticle R and the wafer W are scanned synchronously in the Y direction with respect to the projection optical system PO during the exposure.

The laser plasma light source 10 is a light source of the gas jet cluster system including a high output laser light source 11, a light-collecting lens 12 which collects the laser beam from the laser light source 11 via a window member 15 of the vacuum chamber 1, a nozzle 14 which jets a target gas such as xenon or krypton, and a light-collecting mirror (elliptic reflecting mirror) 13 which has an elliptic reflecting surface. The exposure light EL, radiated from the laser plasma light source 10, is collected or focused on the second focal point of the light-collecting mirror 13. The exposure light EL focused on the second focal point is converted into a substantially parallel light flux via a concave mirror (collimator optical system) 21, and is guided to an optical integrator constructed of a pair of fly's eye optical systems 22, 23.

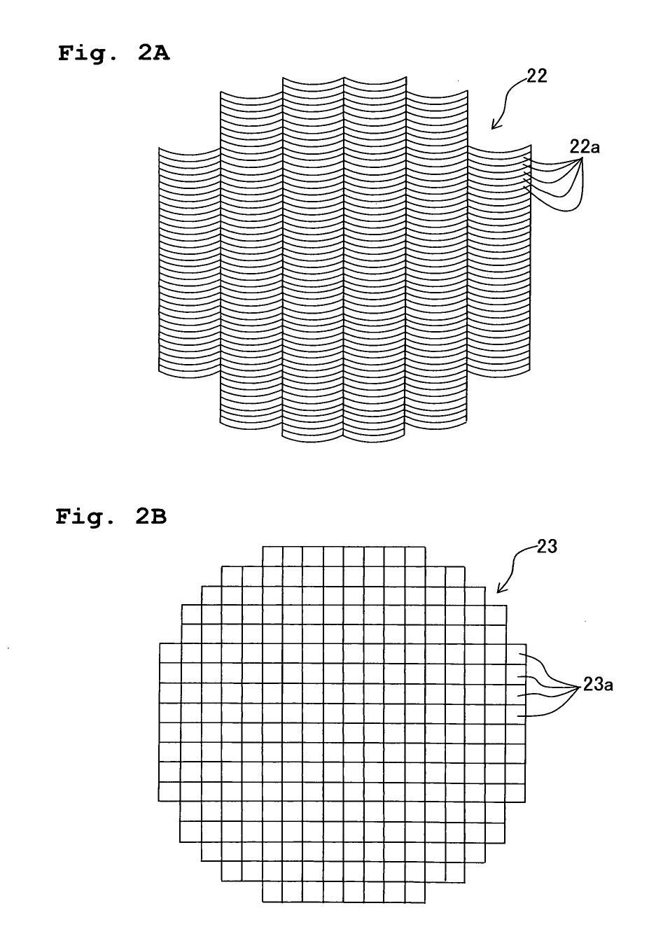

As an example, as shown in FIG. 2A, the first fly's eye optical system 22 is constructed of a large number of reflecting mirror elements 22a each of which has a circular arc-shaped outer shape and which are arranged two-dimensionally. As shown in FIG. 2B, the second fly's eye optical system 23 is constructed of a large number of reflecting mirror elements 23a each of which has a rectangular outer shape and which are arranged two-dimensionally, corresponding to the large number of reflecting mirror elements 22a of the first fly's eye optical system 22. The construction and the function of the fly's eye optical systems 22, 23 are more specifically disclosed, for example, in U.S. Pat. No. 6,452,661. The contents of U.S. Pat. No. 6,452,661 are incorporated herein by reference within a range of permission of the domestic laws and ordinances of the designated state or the selected state.

As shown in FIG. 1, a substantial surface light source, which has a predetermined shape, is formed in the vicinity of the reflecting surface of the second fly's eye optical system 23 (in the vicinity of the light-exit surface of the optical integrator). That is, the plane, on which the substantial surface light source is formed, is the pupil plane of the illumination optical system ILS. An aperture diaphragm AS is arranged at the position of the pupil plane or in the vicinity of the pupil plane. The aperture diaphragm AS representatively illustrates a plurality of aperture diaphragms having apertures of various shapes. By exchanging the aperture diaphragm AS under the control of the main control system 31, it is possible to switch the illumination condition into the ordinary illumination, the zonal or annular illumination, the dipole illumination, the quadruple illumination, or the like.

The exposure light EL, which is allowed to pass through the aperture diaphragm AS, is once focused or collected, and then the exposure light EL is allowed to come into a curved mirror 24. The exposure light EL reflected by the curved mirror 24 is reflected by a concave mirror 25, and then the exposure light EL is allowed to pass through an aperture of a field diaphragm 26 to illuminate a circular arc-shaped illumination area of the reticle surface Ra obliquely from the lower position at a uniform illuminance distribution. A condenser optical system is constructed by the curved mirror 24 and the concave mirror 25. Owing to the condenser optical system, the light (light beam) from the large number of reflecting mirror elements of the second fly's eye optical system 23 illuminates the illumination area of the reticle surface Ra in a superimposed manner. In the exemplary construction shown in FIG. 1, the curved mirror 24 is a convex mirror. However, the curved mirror 24 may be constructed of a concave mirror, and the curvature of the concave mirror 25 may be decreased to an extent corresponding thereto. The illumination optical system ILS is constructed to include the concave mirror 21, the fly's eye optical systems 22, 23, the aperture diaphragm AS, the curved mirror 24, and the concave mirror 25. The reflecting optical members, from the concave mirror 21 to the concave mirror 25, are fixed to a frame (not shown) provided in the vacuum chamber 1 via unillustrated mirror-holding members.

In the illumination optical system ILS of this embodiment, the condenser optical system defines a position which is optically conjugate with the reticle R in the optical path between the second fly's eye optical system 23 and the reticle R, in other words, in the optical path between the second fly's eye optical system 23 and the curved mirror 25. That is, the condenser optical system functions as an imaging optical system which forms, at the conjugate position, an inverted image of the illumination area for illuminating the surface of the reticle R. The reflecting optical member (concave mirror 25), which is disposed closest to the reticle R and which is included in the reflecting optical members constructing the illumination optical system ILS (the concave mirror 21, the pair of fly's eye optical systems 22, 23, the curved mirror 24, and the concave mirror 25), has a reflecting surface which is formed to be concave.

In this embodiment, the position, at which the exposure light EL is once focused or collected on the optical path directed from the second fly's eye optical system 23 to the curved mirror 24, is the conjugate plane (hereinafter referred to as “reticle conjugate plane”) 27 with respect to the reticle surface Ra. The reticle conjugate plane 27 can be also formed on the optical path directed from the curved mirror 24 to the concave mirror 25, for example, by allowing the curved mirror 24 to approach to the second fly's eye optical system 23. The field diaphragm 26 is arranged in the vicinity of the reticle surface Ra. However, the field diaphragm 26 can be also arranged on the reticle conjugate plane 27.

A plane 28, which is conjugate with the pupil plane of the illumination optical system ILS, is formed on the optical path between the curved mirror 24 and the concave mirror 25. In this embodiment, the position (conjugate plane 28), which is conjugate with the pupil plane of the illumination optical system ILS and which is formed between the curved mirror 24 and the concave mirror 25, can be regarded as the position at which the cross-sectional area is smallest or minimized in relation to the light flux of the exposure light EL reflected by the curved mirror 24.

As for the more specific construction and function of the illumination optical system ILS, reference may be made to the contents disclosed in U.S. Provisional Application Ser. No. 60/935,375 (filed on Aug. 9, 2007) and the non-provisional application thereof (U.S. patent application Ser. No. 12/170,933, filed on Jul. 10, 2008) and U.S. Provisional Application Ser. No. 60/935,377 (filed on Aug. 9, 2007) and the non-provisional application thereof (U.S. patent application Ser. No. 12/170,236, filed on Jul. 9, 2008).

On the other hand, the reticle R is attracted and held on the bottom surface of the reticle stage RST via an electrostatic chuck RH. The reticle stage RST is driven at a predetermined stroke in the Y direction by a driving system (not shown) along a guide surface, of the outer surface of the vacuum chamber 1, which is parallel to the XY plane based on control information of the main control system 31 and a measured value obtained by a laser interferometer (not shown). Further, the reticle stage RST is driven in minute amounts in the X direction and the θZ direction (direction of rotation about the Z axis) as well. The reticle R is installed or arranged in the space surrounded by the vacuum chamber 1 via an opening on the upper surface of the vacuum chamber 1. A partition 8 is provided to cover the reticle stage RST on the side of the vacuum chamber 1. The interior of the partition 8 is maintained at a pressure between the atmospheric pressure and the pressure in the vacuum chamber 1 by an unillustrated vacuum pump.

The exposure light EL reflected by the reticle surface Ra is allowed to pass through the aperture of the field diaphragm 26, and the exposure light EL is directed to the projection optical system PO. The projection optical system PO is constructed, as an example, by holding six mirrors M1 to M6 by an unillustrated barrel. The projection optical system PO is a reflection system which is non-telecentric on the side of the object (reticle R) and which is telecentric on the side of the image (wafer W). The projection magnification is a reduction magnification of ¼-fold or the like. The exposure light EL reflected by the reticle R is projected onto the exposure area on the wafer W via the projection optical system PO, transferring a reduction image of the pattern of the reticle R to the wafer W. In the projection optical system PO, the exposure light EL from the reticle R is reflected by the mirror M1 in the upward direction (+Z direction), and then the exposure light EL is reflected by the mirror M2 in the downward direction, followed by being reflected by the mirror M3 in the upward direction and being reflected by the mirror M4 in the downward direction. Subsequently, the exposure light EL is reflected by the mirror M5 in the upward direction, and then is reflected by the mirror M6 in the downward direction to form the image of the pattern of the reticle R on the wafer W. As an example, the mirrors M1, M2, M4, M6 are concave mirrors, and the remaining mirrors M3, M5 are convex mirrors. The projection optical system PO is not limited to the construction shown in FIG. 1, and the number of the reflecting optical members may be any one other than six, which may be, for example, eight.

On the other hand, the wafer W is attracted and held on the wafer stage WST via an electrostatic chuck WH. The wafer stage WST is arranged on a guide surface arranged along the XY plane. The wafer stage WST is driven at predetermined strokes in the X direction and the Y direction by a driving mechanism (not shown) based on the control information of the main control system 31 and the measured value obtained by a laser interferometer (not shown). If necessary, the wafer stage WST is also driven in the direction of rotation about the Z axis, etc.

When one die (shot area) on the wafer W is subjected to the exposure, then the exposure light EL is radiated onto the illumination area of the reticle R by the illumination optical system ILS, and the reticle R and the wafer W are synchronously moved (subjected to the synchronous scanning), with respect to the projection optical system PO, in the Y direction at a predetermined velocity ratio in accordance with the reduction magnification of the projection optical system PO. In this way, one die on the wafer W is exposed with the reticle pattern. After that, the wafer stage WST is driven to step-move the wafer W, and then the next die on the wafer W is subjected to the scanning exposure with the pattern of the reticle R. The plurality of dies on the wafer W are successively exposed with the pattern of the reticle R in the step-and-scan manner as described above.

Upon performing the exposure, the wafer W is arranged at the inside of a partition 7 so that a gas generated from the resist on the wafer W does not exert any harmful influence on the mirrors M1 to M6 of the projection optical system PO. An aperture, which allows the exposure light EL to pass therethrough, is formed through the partition 7. The space in the partition 7 is vacuum-evacuated via a gas discharge tube 36a by a vacuum pump 36 under the control of the main control system 31.

Next, an explanation will be made in detail about the light source chamber 2 included in the vacuum chamber 1, the subchambers 4A to 4E of the illumination system, and the projection system chamber 6 of the exposure apparatus 100 of this embodiment.

In the space in the vacuum chamber 1 shown in FIG. 1, those accommodated in the light source chamber 2 are the light-collecting lens 12 of the laser plasma light source 10, the light-collecting mirror 13, and an end portion of the nozzle 14. The light source chamber 2 is vacuum-evacuated by an unillustrated vacuum pump. The end portion of the light source chamber 2 is disposed in the vicinity of the second focal point of the light-collecting mirror 13. An aperture plate 3, in which an aperture is formed to allow the exposure light EL to pass therethrough in such a state that any shading or eclipse is not brought about, is installed or arranged at the end portion of the light source chamber 2. The cross-sectional area of the exposure light EL is smallest at the second focal point, and hence the aperture can be small-sized, thereby suppressing, by the aperture plate 3, the amount of passage of the debris (scattered particles) generated in the laser plasma light source 10 toward the illumination optical system ILS.

On the other hand, the concave mirror 21 in the illumination optical system ILS, the first fly's eye optical system 22, the second fly's eye optical system 23, the curved mirror 24, and the concave mirror 25 are accommodated in the small-sized box-shaped subchambers 4A, 4B, 4C, 4D, 4E respectively. The subchambers 4A, 4B, 4C, 4D, 4E are vacuum-evacuated by vacuum pumps 33A, 33B, 33C, 33D, 33E via gas discharge nozzles 33Aa, 33Ba, 33Ca, 33Da, 33Ea respectively. As an example, the subchambers 4A to 4E are fixed to the frame (not shown) provided in the vacuum chamber 1 together with unillustrated mirror-holding members for the concave mirror 21 to the concave mirror 25 corresponding thereto.

Openings 4Aa, 4Ab are formed at a portion, of the subchamber 4A accommodating the concave mirror 21, into which the exposure light EL comes and a portion from which the exposure light EL exits, respectively. Cylindrical nozzle members 37A, 38A are provided to surround the openings 4Aa, 4Ab. Openings are formed at portions into and from which the exposure light EL comes and exits, of the subchambers 4B, 4C accommodating the fly's eye optical systems 22, 23 respectively. Cylindrical nozzle members 37B, 37C are provided to surround the openings, respectively.

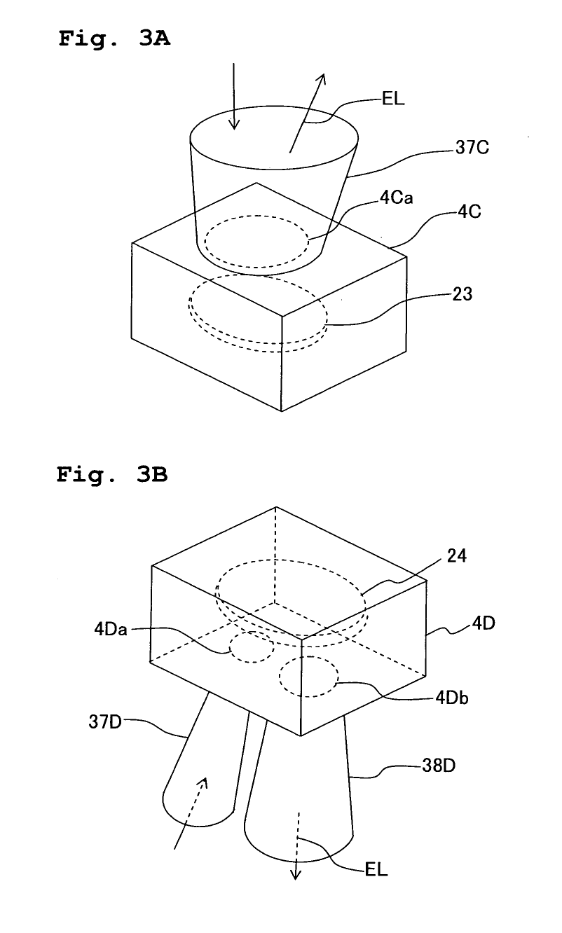

As representatively shown in FIG. 3A, the nozzle member 37C, provided to surround an opening 4Ca of the subchamber 4C accommodating the second fly's eye optical system 23, has an end portion which is gradually widened so that the incoming or incident light and the outgoing or exiting light are not blocked or shielded thereby.

Further, openings 4Da, 4Db are formed at a portion, of the subchamber 4D accommodating the curved mirror 24 shown in FIG. 1, into which the exposure light EL comes and a portion of the subchamber 4D from which the exposure light EL exits, respectively. The opening 4Da, which is disposed on the light-incident side, is arranged on the reticle conjugate plane 27 or in the vicinity of the reticle conjugate plane 27. The opening 4Db, which is disposed on the light-exit side, is arranged on the plane 28 conjugate with the pupil plane of the illumination optical system ILS or in the vicinity of the plane 28. In other words, the openings 4Da, 4Db are arranged at positions at which the cross-sectional area of the light flux coming into the curved mirror 24 and the cross-sectional area of the light flux reflected by the curved mirror 24 are smallest, or in the vicinity of the positions, respectively. Cylindrical nozzle members 37D, 38D are provided to surround the openings 4Da, 4Db and surround the exposure light EL. The phrase “vicinity of the position at which the cross-sectional area of the light flux is smallest” means, for example, positions until arrival at 2φ provided that φ represents the diameter of the light flux at the “position at which the cross-sectional area of the light flux is smallest”. By providing such a range, it is possible to decrease the cross-sectional area of the opening depending on the light flux, and it is possible to suppress the entering or inflow of the minute particles such as the debris into the individual chambers accommodating the reflecting optical elements respectively. FIG. 1 shows, as an example, that the reticle conjugate plane 27 is positioned nearer to the light-incident side than the opening 4Da. However, it will be easily appreciated that the reticle conjugate plane 27 may be positioned at the opening 4Da by adjusting the arrangement of, for example, the mirrors 21 to 25.

As shown in FIG. 3B, each of the nozzle members 37D, 38D is widened in conformity with the cross-sectional shape of the exposure light EL so as not to block or shield the exposure light EL. That is, each of the nozzle members 37D, 38D is a cylinder which extends along the incident light flux of the exposure light EL from the subchamber 4D to the mirror 24 or the reflecting light flux. The inner diameter of the cylinder is decreased at positions nearer to the subchamber 4D (mirror 24). Although not shown in FIG. 3B, the position at which the cross-sectional area of the light flux is smallest (convergent portion of the light flux), or the reticle conjugate plane 27 in this case, is positioned in each of the nozzle members (cylinders) 37D, 38D. Alternatively, the convergent portion of the light flux may be positioned at the end, of each of the nozzle members (cylinders) 37D, 38D, on the side of the subchamber 4D, i.e., at each of the openings 4Da, 4Db. The inner diameter may be increased at positions nearer to the subchamber 4A (mirror 21) in conformity with the cross-sectional shape of the exposure light EL. With reference to FIG. 1 again, an opening is also formed at a portion, of the subchamber 4E accommodating the concave mirror 25, into and from which the exposure light EL comes and exits. A cylindrical nozzle member 37E is provided to surround the opening and surround the exposure light.

It is preferable that each of the aperture plate 3, the subchambers 4A to 4E, and the nozzle members 37A to 37E, 38A, 38D is formed of, for example, molybdenum (Mo) that is a highly heat-resistant material or a molybdenum alloy such as chromium-molybdenum steel.

For example, two openings are provided for the subchamber 4A into which and from which the exposure light EL comes and exits. However, the openings may be integrated into one opening. On the contrary, the opening of each of the subchambers 4C, 4E may be formed as two separate openings into which and from which the exposure light EL comes and exits.

The vacuum pumps 32, 33A to 33E, which are constructed of turbo pumps, etc. are provided with barometers respectively. The main control system 31 controls the vacuum pumps 32, 32A to 33E based on the measured values obtained by the barometers so that the predetermined degree of vacuum is provided in each of the space in the vacuum chamber 1 and the spaces in the subchambers 4A to 4E. As an example, the air pressure in the space in the vacuum chamber 1 is about 10⁻⁵ Pa, the air pressure in the light source chamber 2 is about 10⁻⁶ to 10⁻⁷ Pa, and the air pressure in the space in each of the subchambers 4A to 4E is about 10⁻⁶ Pa. That is, the degrees of vacuum in the subchambers 4A to 4E are set to be higher than that in the space in the vacuum chamber 1. The subchambers 4A to 4E are communicated with the space in the vacuum chamber 1 via the openings respectively. However, since the high degree of vacuum is also provided in the vacuum chamber 1, an amount of gas, allowed to inflow into the inside of the subchambers 4A to 4E from the outside of the subchambers 4A to 4E, is slight.

In this embodiment, the interiors of the subchambers 4A to 4E are always vacuum-evacuated (sucked) by the vacuum pumps 33A to 33E. Accordingly, it is possible to efficiently discharge (remove or expel), to the outside, the minute particles such as the debris in the vicinity of the reflecting surface of each of the reflecting optical members ranging from the concave mirror 21 to the concave mirror 25 in the subchambers 4A to 4E. Further, the minute particles, which are generated by the irradiation of the exposure light EL, onto the multilayered films of the reflecting surfaces, etc., are also discharged simultaneously. Therefore, the amount of adhesion of the minute particles to the reflecting surfaces of the reflecting optical members is decreased to thus prolong the time until arrival at such a situation that the reflectance of each of the reflecting optical members is decreased to be lower than an allowable range, thereby prolonging the maintenance interval of the illumination optical system ILS. Thus, the rate of operation of the exposure apparatus 100 is improved. It is not necessarily indispensable that the exposure apparatus 100 or the illumination optical system ILS is equipped with the vacuum pumps 32, 33A to 33E. It is also allowable to use a vacuum pump provided in the production site in which the exposure apparatus is installed.

In particular, in the case of the subchamber 4D accommodating the curved mirror 24, the openings 4Da, 4Db are disposed at the positions at which the cross-sectional area of the light flux coming into the curved mirror 24 and the cross-sectional area of the light flux reflected by the curved mirror 24 are smallest, or in the vicinity the positions, respectively. Therefore, it is possible to make the openings 4Da, 4Db to be small. Therefore, the amount of the minute particles diffused from the outside into the subchamber 4D is decreased, and the amount of adhesion of the minute particles to the reflecting surface of the curved mirror 24 is decreased. Further, it is possible to increase the difference in the air pressure between the inside of the vacuum chamber 1 and the inside of the subchamber 4D. Therefore, the transmittance of the exposure light EL is improved, and it is possible to improve the illuminance of the exposure apparatus 100 on the wafer. Therefore, it is possible to improve the throughput.

The subchambers 4A to 4E are provided with the nozzle members 37A and 38A; 37B; 37C; 37D and 38D; and 37E, respectively. Therefore, the air pressure is decreased on the optical path for the exposure light EL by the vacuum evacuation performed by the vacuum pumps 33A to 33E. Therefore, the transmittance of the exposure light EL is improved, and it is possible to improve the throughput. It is not necessarily indispensable to provide the nozzle members 37A to 37E, 38A, 38D except for a case in which the convergent portion of the light flux is defined in relation to the nozzle member. Some of the nozzle members 37A to 37E, 38A, 38D may be omitted. For example, it is also allowable that only one of the nozzle members 37D, 38D of the subchamber 4D is provided. The projection optical system PO is accommodated in the projection system chamber 6. The space in the projection system chamber 6 is vacuum-evacuated via the gas discharge tube 35a by the vacuum pump 35. The opening, through which the exposure light EL passes, is formed at a portion of the projection system chamber 6 opposite to or facing the reticle R. The opening, through which the exposure light EL passes, is also formed at a portion of the projection system chamber 6 opposite to or facing the wafer W.

The vacuum pump 35 is also provided with a barometer. The main control system 31 controls the vacuum pump 35 based on the measured value obtained by the barometer so that the interior of the projection system chamber 6 has a predetermined degree of vacuum. As an example, the air pressure of the space in the projection system chamber 6 is about 10⁻⁵ to 10⁻⁶ Pa.

The function and the effect of this embodiment are as follows.

(1) The illumination optical apparatus (the laser plasma light source 10 and the illumination optical system ILS) of the exposure apparatus 100 shown in FIG. 1 is the reflection type illumination optical apparatus which guides the exposure light EL (illumination light) from the laser plasma light source 10 to the reticle surface Ra (illumination objective surface), and includes the vacuum chamber 1 (first chamber) accommodating the plurality of reflecting optical elements from the concave mirror 21 to the concave mirror 25, and the subchamber 4D (second chamber) arranged in the vacuum chamber 1 and accommodating the curved mirror 24 (first reflecting optical element). The subchamber 4D has the opening 4Da via which the exposure light EL comes into the curved mirror 24 and passes therethrough, and the opening 4Db through which the exposure light EL reflected by the curved mirror 24 passes. The opening 4Da is arranged at the position (reticle conjugate plane 27) at which the cross-sectional area of the light flux, coming into the curved mirror 24, is smallest or in the vicinity of the position. The opening 4Db is arranged at the position at which the cross-sectional area of the light flux reflected by the curved mirror 24 is smallest or in the vicinity of the position (plane 28).

According to this embodiment, the curved mirror 24 is accommodated in the individual subchamber 4D on which the openings 4Da, 4Db are formed on the optical path for the exposure light EL. Further, the positions of the openings 4Da, 4Db are the positions at which the cross-sectional area of the exposure light EL is small. Therefore, it is possible to realize the small sizes of the openings.

Therefore, the minute particles such as the debris, which are diffused from the laser plasma light source 10, hardly adhere to the reflecting surface of the curved mirror 24, thereby making it possible to maintain the reflectance of the curved mirror 24 to be high, and thus prolonging the maintenance interval of the illumination optical system ILS. Further, since the vacuum space is maintained locally, it is unnecessary to excessively enhance the ability of the vacuum gas discharge mechanism as compared with a case in which the entire space in the vacuum chamber 1 is made to have a higher degree of vacuum.

(2) There are provided the main control system 31 and the vacuum pumps 32, 33D (pressure controllers) controlling the pressure in the subchamber 4D to be lower than the pressure in the vacuum chamber 1. Therefore, the minute particles are discharged or removed by the suction, and it is possible to maintain the high transmittance of the exposure light EL.

The illumination optical system ILS includes the concave mirror 25 (second reflecting optical element) and the second fly's eye optical system 23 (optical integrator) having the large number of reflecting mirror elements 23a. The exposure light EL reflected by the large number of reflecting mirror elements 23a respectively comes into the curved mirror 24 via the opening 4Da, and exits via the opening 4Db. The curved mirror 25 guides, to the reticle surface, the exposure light EL reflected by the curved mirror 24.

In this case, the reflectance of the curved mirror 24 is maintained to be high. Therefore, the exposure light EL from the large number of reflecting mirror elements 23a can be correctly superimposed to illuminate the reticle surface therewith, maintaining the uniformity of the illuminance distribution to be high on the reticle surface.

(3) The illumination optical system ILS constitutes the optical system which forms or defines the reticle conjugate plane 27 in the space up to the reticle surface. In FIG. 1, the opening 4Da of the subchamber 4D is arranged in the vicinity of the reticle conjugate plane 27 (more preferably on the reticle conjugate plane 27). The cross-sectional area of the light flux is smallest on the reticle conjugate plane 27. Therefore, the opening 4Da can be smallest or minimized approximately to the utmost extent, further enhancing the effect of avoiding the adhesion of the minute particles.

If the reticle conjugate plane 27 is formed in the vicinity of the curved mirror 24 on the optical path directed from the curved mirror 24 to the curved mirror 25 depending on the position of the curved mirror 24, then it is allowable that the opening 4Da is arranged at a position nearer to the curved mirror 24 as much as possible; and that the opening 4Db on the light-exit side is arranged at a position near to the reticle conjugate plane 27, on condition that the necessary spacing distance (spacing distance capable of lowering the air pressure in the subchamber 4D as compared with the air pressure in the vacuum chamber 1) is maintained with respect to the reflecting surface of the curved mirror 24.

(4) As for the illumination optical system ILS, the plane 28, which is conjugate with the pupil plane of the illumination optical system ILS, is formed between the curved mirror 24 and the concave mirror 25, and the opening 4Db is arranged in the vicinity of the plane 28 (more preferably on the pupil plane or the plane 28). Accordingly, the opening 4Db can be small-sized.

Further, the vacuum pump 33D (pressure-reducing device) is provided. The vacuum pump 33D reduces the pressure of the interior of the subchamber 4D separately from the interior of the vacuum chamber 1, and is provided with the gas discharge nozzle 33Da having the gas discharge port provided in the vicinity of the reflecting surface of the curved mirror 24 in the subchamber 4D. Therefore, the minute particles such as the debris, which exist or are present in the vicinity of the reflecting surface of the curved mirror 24, are excluded by the suction or the evacuation. Therefore, the reflectance of the reflecting surface is maintained to be high. The minute particles, generated by the interaction between the exposure light EL (EUV light) and the reflective film of the reflecting surface, are also discharged or removed by the suction or the evacuation. Therefore, any harmful influence, which would be otherwise exerted on other optical members, is decreased.

(5) In FIG. 1, the subchambers 4A to 4E are independently vacuum-evacuated by the vacuum pumps 33A to 33E. However, for example, a plurality of the subchambers (for example, the subchambers 4D, 4E) may be vacuum-evacuated by a common vacuum pump (a turbo pump, etc.).

(6) The nozzle members 37D, 38D (surrounding members) are provided to surround the optical path for the exposure light EL passing through the two openings of the subchamber 4D. Therefore, the minute particles on the optical path for the exposure light EL can be efficiently discharged by the suction or the evacuation. Further, it is possible to lower the air pressure of the optical path for the exposure light EL. Thus, the transmittance of the exposure light EL is improved. Even by providing only one of the nozzle members 37D, 38D, the effect of discharging the minute particles from the optical path is improved. Further, the end portions of the nozzle members 37D, 38D (on the side opposite to the subchamber 4D) can be regarded as the inlet/outlet ports for the substance (minute particles) and the light between the subchamber 4D and the outside thereof. Therefore, owing to the presence, in each of the nozzle members 37D and 38D, of the convergent portion of the incident light flux or the reflected light flux of the exposure light EL coming into or exiting from the mirror 24, the inner diameters of the nozzle members 37D, 38D can be decreased, thereby making it possible to make the minute particles such as the debris to hardly enter the interior of the subchamber 4D from the end portion of each of the nozzle members 37D, 38D.

(7) The subchamber 4E (third chamber) is provided. The subchamber 4E is arranged in the vacuum chamber 1 and accommodates the concave mirror 25. The subchamber 4E has the opening through which the light flux comes into the concave mirror 25 and through which the light flux reflected by the concave mirror 25) passes; and the vacuum pumps 32, 33E (pressure controllers) control the pressure in the subchamber 4E to be lower than the pressure in the vacuum chamber 1, thereby decreasing the amount of adhesion of the minute particles onto the reflecting surface of the concave mirror 25 disposed near to the reticle surface as well. Further, the transmittance of the exposure light EL in the subchamber 4E is maintained to be high. The amount of the minute particles directed, for example, to the projection optical system disposed on the downstream side is decreased.

In the case of the system in which those disposed in the vicinity of the reflecting surfaces of the plurality of reflecting optical members are locally vacuum-evacuated as described above, the abilities (capacities) of the individual vacuum pumps 33A to 33E may be low. Therefore, it is unnecessary to excessively enhance the ability of the vacuum gas discharge mechanism.

In a case that the angle of incidence and the angle of reflection of the exposure light EL are small with respect to the subchambers 4A, 4D, it is also possible that one opening is used as both of the two openings 4Ea, 4Db of the subchamber 4D and one opening is used as both of the two openings 4Aa, 4Ab of the subchamber 4A.

(8) The exposure apparatus 100 shown in FIG. 1 is provided with the illumination optical apparatus as described above, and the projection optical system PO which projects, onto the surface of the wafer W (projection surface), the image of the reflection type master plate which can be arranged on the reticle surface Ra. The projection optical system PO is accommodated in the projection system chamber 6 which is distinct from the subchambers 4A to 4E accommodating the plurality of reflecting optical elements of the illumination optical apparatus.

In this case, the transmittance of the illumination optical apparatus is high. Further, the minute particles such as the debris, passing through the illumination optical apparatus, are hardly diffused into the projection optical system PO. Therefore, the transmittance of the projection optical system PO is also maintained to be high, and it is possible to perform the exposure at a high throughput.

In the embodiment described above, the subchambers are provided for the mirrors 21 to 25 respectively. However, it is also allowable that, except for the subchamber 4D, all or some of the remaining subchambers are omitted.

### Second Embodiment

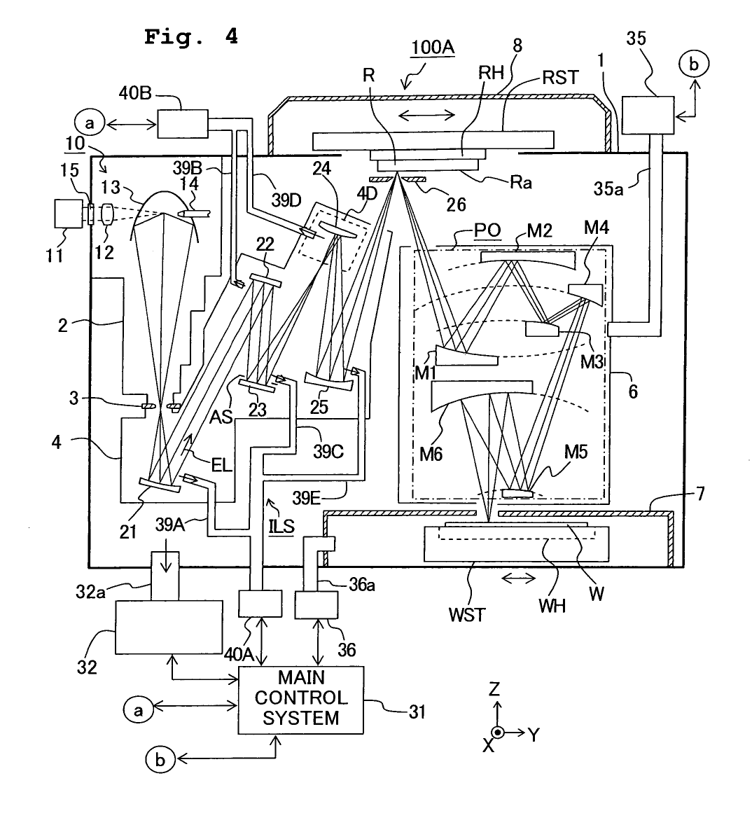

The second embodiment of the present invention will be explained with reference to FIG. 4. In FIG. 4, the components or parts, which correspond to those shown in FIG. 1, are designated by the same or similar reference numerals, the detailed explanation of which will be omitted.

FIG. 4 shows a sectional view of a schematic construction of an exposure apparatus 100A of this embodiment. With reference to FIG. 4, all of the reflecting optical members from the concave mirror 21 to the concave mirror 25 constructing the illumination optical system ILS are accommodated in an illumination system chamber 4 provided in the vacuum chamber 1. A light source chamber 2 and the illumination system chamber 4 are connected by an aperture plate 3. A small opening, which allows the exposure light EL to pass therethrough, is provided at a partition wall of the illumination system chamber 4 on the optical path for the exposure light EL directed from the concave mirror 25 to the reticle surface Ra.

Vacuum pumps 40A, 40B, which are controlled by a main control system 41, are provided. Three gas discharge nozzles 39A, 39C, 39E are connected to the vacuum pump 40A, and two discharge nozzles 39B, 39D are connected to the vacuum pump 40B. Further, gas discharge ports, which are disposed at the end portions of the gas discharge nozzles 39A, 39B, 39C, 39D, 39E, are arranged in the vicinity of the reflecting surfaces of the concave mirror 21, the first fly's eye optical system 22, the second fly's eye optical system 23, the curved mirror 24, and the concave mirror 25, respectively, disposed in the illumination system chamber 4. Those other than the above are constructed in the same manner as in the first embodiment shown in FIG. 1.

With reference to FIG. 4, the gas, in the vicinity of the reflecting surfaces of all of the reflecting optical members ranging from the concave mirror 21 to the concave mirror 25 in the illumination system chamber 4, is sucked (vacuum-evacuated) by the vacuum pumps 40A, 40B. By doing so, the air pressure in the illumination system chamber 4 is set to be lower than the air pressure in the vacuum chamber 1. Further, the minute particles such as the debris, which are diffused from the laser plasma light source 10 into the illumination system chamber 4, are efficiently discharged before the minute particles adhere to the reflecting surfaces. Therefore, the reflectances of the reflecting surfaces of those ranging from the concave mirror 21 to the concave mirror 25 are maintained to be high.

The function and the effect of this embodiment are as follows.

(1) The illumination optical apparatus (the laser plasma light source 10 and the illumination optical system ILS) of the exposure apparatus 100A of the embodiment shown in FIG. 4 is the reflection type illumination optical apparatus which guides the exposure light EL (illumination light) to the reticle surface Ra (illumination objective surface), and includes the illumination system chamber 4 (or the vacuum chamber 1) which accommodates the plurality of reflecting optical elements ranging from the concave mirror 21 to the concave mirror 25, the gas discharge nozzle 39D which has the gas discharge port arranged in the vicinity of the reflecting surface of the curved mirror 24 (first reflecting optical element), and the vacuum pump 40B which discharges the gas via or through the gas discharge nozzle 39D.

According to this embodiment, the vacuum evacuation and/or the suction of the gas containing the minute particles is/are locally performed via the gas discharge nozzle 39D in the vicinity of the reflecting surface of the curved mirror 24. Therefore, the minute particles such as the debris, which are diffused from the laser plasma light source 10, hardly adhere to the reflecting surface of the curved mirror 24. In particular, the transmittance of the exposure light EL is maintained to be high in the vicinity of the reflecting surface. Further, the vacuum evacuation, etc. is locally performed. Therefore, it is unnecessary to excessively enhance the ability of the vacuum gas discharge mechanism as compared with a case in which the entire atmosphere is made to have a higher degree of vacuum.

(2) In FIG. 4, as indicated by dotted lines, a box-shaped subchamber 4D (second chamber) may be provided to accommodate the curved mirror 24 in the illumination system chamber 4. This may be also adopted equivalently, for example, for the another concave mirror 21. Accordingly, the minute particles more hardly adhere to the curved mirror 24.

(3) There are provided the gas discharge nozzle 39E which has the gas discharge port arranged in the vicinity of the reflecting surface of the concave mirror 25 (second reflecting optical element) and the vacuum pump 40A which discharges the gas from the gas discharge nozzle 39E. Therefore, the reflectance is maintained to be high also on the concave mirror 25. The transmittance of the exposure light EL is maintained to be high particularly in the vicinity of the reflecting surface of the concave mirror 25.

The foregoing embodiments can be modified as follows.

(1) In the embodiments described above, the laser plasma light source is used as the exposure light source. However, there is no limitation to this. It is also allowable to use any one of the SOR (Synchrotron Orbital Radiation) ring, the betatron light source, the discharged light source, the X-ray laser, etc.

(2) The embodiments described above are illustrative of the case in which the EUV light is used as the exposure light, and the projection optical system of the all reflection type constructed of only six mirrors is used. However, this case is described by way of example. The present invention is also applicable, for example, to an exposure apparatus provided with a projection optical system which is constructed of only four mirrors as a matter of course, as disclosed in Japanese Patent Application Laid-open No. 11-345761, and an exposure apparatus provided with a projection optical system which has, for example, four to eight mirrors and which uses, as the light source, a VUV light source having a wavelength of 100 to 160 nm, for example, an Ar₂ laser (wavelength: 126 nm).

(3) The construction of the illumination optical system ILS is not limited to the construction including those ranging from the concave mirror 21 to the concave mirror 25 as shown in FIG. 1. In principle, it is enough that a plurality of reflecting optical members are included.

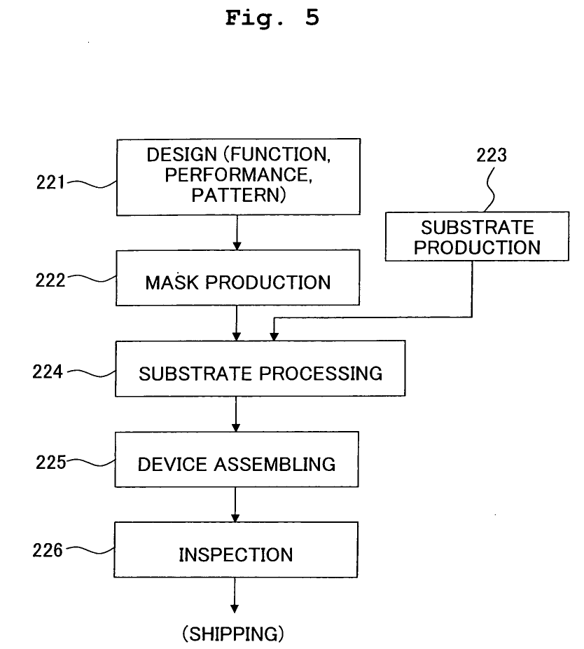

In a case that an electronic device such as a semiconductor device (or a microdevice) is produced by using the exposure apparatus of the embodiment described above, then as shown in FIG. 5, the electronic device is produced by performing a step 221 of designing the function and the performance of the electronic device; a step 222 of manufacturing a mask (reticle) based on the designing step; a step 223 of producing a substrate (wafer) as a base material for the device and coating the substrate (wafer) with the resist; a substrate-processing step 224 including a step of exposing the substrate (photosensitive substrate) with the pattern of the mask by the exposure apparatus (EUV exposure apparatus) of the embodiment described above, a step of developing the exposed substrate, a step of heating (curing) and etching the developed substrate, etc.; a step 225 of assembling the device (including processing processes such as a dicing step, a bonding step, and a packaging step); an inspection step 226; and the like.

In other words, the method for producing the device includes exposing the substrate (wafer) disposed on the projection surface by using the exposure apparatus of the embodiment described above, and processing the exposed substrate (Step 224). In this procedure, according to the exposure apparatus of the embodiment described above, the debris or the like, which are generated in the laser plasma light source 10, hardly adhere to the mirror of the illumination optical system ILS, etc; and the transmittance of the illumination optical system ILS is maintained to be high, thereby reducing the maintenance cost for the exposure apparatus. Further, since the intensity of the exposure light EL is maintained to be high, it is possible to produce a high-performance device at a high throughput.

The exposure apparatus 100, 100A (EUV exposure apparatus) of the embodiment described above is produced by assembling the various subsystems including the respective constitutive elements such as the illumination optical apparatus (the laser plasma light source 10, the illumination optical system ILS) as defined in claims of this application so that the predetermined mechanical accuracy, electric accuracy and optical accuracy are maintained. In order to secure the various accuracies, those performed before and after the assembling include the adjustment for achieving the optical accuracy for the various optical systems, the adjustment for achieving the mechanical accuracy for the various mechanical systems, and the adjustment for achieving the electric accuracy for the various electric systems. The steps of assembling the various subsystems into the exposure apparatus include the mechanical connection, the wiring connection of the electric circuits, the piping connection of the air pressure circuits, etc. in correlation with the various subsystems. It goes without saying that the steps of assembling the respective individual subsystems are performed before performing the steps of assembling the various subsystems into the exposure apparatus. When the steps of assembling the various subsystems into the exposure apparatus are completed, the overall adjustment is performed to secure the various accuracies as the entire exposure apparatus. It is desirable that the exposure apparatus is produced in a clean room in which the temperature, the cleanness, etc. are managed.

According to the illumination optical apparatus and the exposure apparatus including the illumination optical apparatus of the present invention, the debris and/or the like hardly adhere to the mirror of the illumination optical system and/or the like. Therefore, the maintenance cost is reduced for the illumination optical apparatus and the exposure apparatus. Accordingly, the high-performance device can be produced at a high throughput by using the present invention. Therefore, the present invention will remarkably contribute to the international development of the precision mechanical equipment industry including the semiconductor industry.

What is claimed is:

1. A reflection type illumination optical apparatus which guides an illumination light to an illumination objective surface, the illumination optical apparatus comprising:
a first chamber which accommodates a plurality of reflecting optical elements; and
a second chamber which is arranged in the first chamber and which accommodates a first reflecting optical element among the plurality of reflecting optical elements;
wherein the second chamber has a first opening through which a light flux of the illumination light coming into the first reflecting optical element passes, and a second opening through which the light flux of the illumination light reflected by the first reflecting optical element passes;
the first opening is arranged at a position at which a cross-sectional area of the light flux coming into the first reflecting optical element is smallest or the first opening is arranged in the vicinity of the position; and
the second opening is arranged at a position at which a cross-sectional area of the light flux reflected by the first reflecting optical element is smallest or the second opening is arranged in the vicinity of the position.

2. The illumination optical apparatus according to claim 1, further comprising a pressure controller which controls a pressure in the second chamber to be lower than a pressure in the first chamber.

3. The illumination optical apparatus according to claim 1, wherein the plurality of reflecting optical elements include an optical integrator which has a large number of reflecting mirror elements, and a second reflecting optical element;
the illumination light, which is reflected by the large number of reflecting mirror elements, comes into the first reflecting optical element via the first opening, and the illumination light exits via the second opening; and
the illumination light, which is reflected by the first reflecting optical element, is guided by the second reflecting optical element to the illumination objective surface.

4. The illumination optical apparatus according to claim 3, wherein the plurality of reflecting optical elements constructs an optical system which defines a position, conjugate with the illumination objective surface, between the illumination objective surface and the plurality of reflecting optical elements; and
the first opening is arranged at the conjugate position or at a position disposed in the vicinity thereof.

5. The illumination optical apparatus according to claim 4, wherein the optical system defines, between the first reflecting optical element and the second reflecting optical element, a position of a pupil plane of the optical system or a position conjugate with the pupil plane; and
the second opening is arranged at the position of the pupil plane of the optical system or the position conjugate with the pupil plane.

6. The illumination optical apparatus according to claim 1, further comprising a pressure-reducing device which includes a gas discharge port provided in the vicinity of a reflecting surface of the first reflecting optical element in the second chamber and which reduces a pressure in the second chamber separately from the first chamber.

7. The illumination optical apparatus according to claim 6, wherein the pressure-reducing device has a first vacuum pump which is connected to the gas discharge port in the second chamber.

8. The illumination optical apparatus according to claim 1, further comprising a surrounding member which is provided for at least one of the first opening and the second opening and which surrounds an optical path for the illumination light passing through at least one of the first opening and the second opening.

9. The illumination optical apparatus according to claim 3, further comprising a third chamber which accommodates the second reflecting optical element;
wherein the third chamber has an opening through which the light flux of the illumination light coming into the second reflecting optical element and the light flux of the illumination light reflected by the second reflecting optical element pass; and
the pressure controller controls a pressure in the third chamber to be lower than the pressure in the first chamber.

10. A reflection type illumination optical apparatus which guides an illumination light to an illumination objective surface, the illumination optical apparatus comprising:
a first chamber which accommodates a plurality of reflecting optical elements;
a first gas discharge nozzle which is arranged in the vicinity of a reflecting surface of a first reflecting optical element among the plurality of reflecting optical elements; and
a first gas discharge device which discharges a gas existing in the vicinity of the reflecting surface of the first reflecting optical element via the first gas discharge nozzle.

11. The illumination optical apparatus according to claim 10, further comprising a second chamber which is arranged in the first chamber and which accommodates the first reflecting optical element.

12. The illumination optical apparatus according to claim 11, further comprising a third chamber which is arranged in the first chamber and which accommodates a second reflecting optical element among the plurality of reflecting optical elements.

13. The illumination optical apparatus according to claim 10, further comprising:
a second gas discharge nozzle which is arranged in the vicinity of a reflecting surface of a second reflecting optical element among the plurality of reflecting optical elements; and
a second gas discharge device which discharges a gas existing in the vicinity of the reflecting surface of the second reflecting optical element via the second gas discharge nozzle.

14. A reflection type illumination optical apparatus which guides an illumination light to an illumination objective surface, the illumination optical apparatus comprising:
a first chamber which accommodates a plurality of reflecting optical elements; and
a second chamber which is arranged in the first chamber and which accommodates a first reflecting optical element among the plurality of reflecting optical elements;
wherein the second chamber is provided with a cylindrical portion which extends from the second chamber so that a light flux of the illumination light, coming into or reflected by the first reflecting optical element, passes through an interior of the cylindrical portion; and a position, at which a cross-sectional area of the light flux coming into or reflected by the first reflecting optical element is smallest, exists in the cylindrical portion.

15. The illumination optical apparatus according to claim 14, wherein the cylindrical portion includes a first cylindrical portion in which the light flux of the illumination light coming into the first reflecting optical element passes through an interior of the first cylindrical portion, and a second cylindrical portion in which the light flux of the illumination light reflected by the first reflecting optical element passes through an interior of the second cylindrical portion.

16. The illumination optical apparatus according to claim 14, wherein inner diameters of the cylindrical portion are decreased at positions nearer to the second chamber.

17. The illumination optical apparatus according to claim 15, wherein an extending direction of the first cylindrical portion is different from that of the second cylindrical portion.

18. The illumination optical apparatus according to claim 14, further comprising a pressure controller which controls a pressure in the second chamber to be lower than a pressure in the first chamber.

19. The illumination optical apparatus according to claim 1, wherein the second chamber is formed of molybdenum or alloy thereof.

20. An exposure apparatus comprising:
the illumination optical apparatus as defined in claim 1; and
a projection optical system which projects, onto a projection surface, an image of a reflection type master plate arrangeable on the illumination objective surface;
wherein the projection optical system is accommodated in a projection system chamber which is different from the first chamber.

21. The exposure apparatus according to claim 20, wherein the first chamber accommodates the projection system chamber.

22. The exposure apparatus according to claim 20, further comprising an apparatus chamber which accommodates the first chamber and the projection system chamber.

23. The exposure apparatus according to claim 20, further comprising an EUV light source.

24. A method for producing a device, comprising:
exposing a substrate disposed on a projection surface by using the exposure apparatus as defined in claim 20; and
processing the exposed substrate.

25. The illumination optical apparatus according to claim 14, wherein the second chamber is formed of molybdenum or alloy thereof.

26. An exposure apparatus comprising:
the illumination optical apparatus as defined in claim 14; and
a projection optical system which projects, onto a projection surface, an image of a reflection type master plate arrangeable on the illumination objective surface;
wherein the projection optical system is accommodated in a projection system chamber which is different from the first chamber.
